(19) United States
(12) Patent Application Publication
(10) Pub. No.: US 2017/0157994 A1
(43) Pub. Date: Jun. 8, 2017

(54) Tire Comprising a Mark Including a Plurality of Grey Levels

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Olivier MUHLHOFF, Clermont-Ferrand Cedex 9 (FR); Jean-Claude DESVIGNES, Clermont-Ferrand Cedex 9 (FR); Helene EMORINE, Clermont-Ferrand Cedex 9 (FR); Mathieu VANDAELE, Clermont-Ferrand Cedex 9 (FR)

(21) Appl. No.: 15/325,673

(22) PCT Filed: Jul. 10, 2015
(86) PCT No.: PCT/EP2015/065859

§ 371 Date: Jan. 11, 2017

(30) Foreign Application Priority Data
Jul. 11, 2014 (FR) 1456696

(51) Int. Cl. B60C 13/00; B29D 30/72; B60R 13/00; B60C 11/24; B60C 13/02; B29D 30/08; B44C 1/00

(52) U.S. Cl. CPC B60C 13/001; B29D 30/08; B29D 30/72; B44C 1/00; B60C 11/24; B60C 13/02; B60R 13/00

(57) ABSTRACT

A tire (1) made of rubber material, comprising a tread (2) and a sidewall (3), said tire (1) comprising a marking (4) on the tread (2) and/or said sidewall (3). The marking (4) is divided into a plurality of basic zones (50) of the same size, each basic zone (50) being able to be inscribed in a circle of diameter equal to 8 mm, each basic zone (50) comprising between 0 and N motifs (6), said motifs being formed integrally with the tire so as to define a grey level (Nx) of the basic zone (50) from N+1 grey levels (Nx), the grey level of a basic zone (50) depending on the number of motifs present in this basic zone (50). The marking (4) on the tire comprises at least 5 different grey levels.

### FIELD OF THE INVENTION

The present invention relates to a tire for a motor vehicle, having a tread and a sidewall, said tire comprising a marking on the tread and/or said sidewall.

### PRIOR ART

For aesthetic reasons, tires have markings on their treads and/or their sidewalls which are produced increasingly from source images which are printed and which are notably photographs, or works by artists or graphic designers. Said source markings are made up of different shades of colour which are able to be transposed into different corresponding grey levels.

The document WO 2013/113526 discloses a tire having a marking on a sidewall. This marking consists of a realistic representation of a photograph. More particularly, the marking is made up of a plurality of adjacent ribs having a triangular overall section. The space between two adjacent ribs is filled with a complementary material to a particular filling level. The filling level of the complementary material locally determines a grey level of the marking.

The aim of the invention is to propose a solution that makes it possible to realize complex markings, of the photographic representation type, on a tire in a simpler and more economical manner than in the prior art.

### DEFINITIONS

A “tire” means all types of resilient tread, whether or not it is subjected to an internal pressure.

A “rubber material” means a diene elastomer, that is to say, in a known way, an elastomer which is based, at least partially (i.e. is a homopolymer or a copolymer), on diene monomers (monomers bearing two conjugated or non-conjugated carbon-carbon double bonds).

The “tread” of a tire means a quantity of rubber material delimited by lateral surfaces and by two main surfaces, one of which, referred to as the tread surface, is intended to come into contact with a road surface when the tire is being driven on.

The “sidewall” of a tire means a lateral surface of the tire, said surface being disposed between the tread of the tire and a bead of this tire.

A “strand” means a filiform element, the height of which is at least equal to twice the diameter of a disc having the same surface area as the mean cross section of the strand.

“Lamellae” means elongate strands which have a length at least equal to twice their height.

“Lightness” means the parameter which characterizes a surface to reflect light to a greater or lesser extent. Lightness is expressed using a scale that ranges from 0 to 100 according to the L*a*b* colour model established by the CIE (International Commission on Illumination) in 1976. The value 100 represents white or total reflection; the value 0 represents black or total absorption. In this colour model, a* and b* are chromaticity coordinates. The L*a*b* colour model thus defines a chromaticity diagram. In this diagram, a* and b* indicate the direction of the colours: +a* goes towards red, −a* towards green, +b* towards yellow, and −b* towards blue. The centre of the diagram is achromatic. Saturation increases as the values a* and b* rise and thus with increasing distance from the centre of the diagram.

A “motif” means a geometric element protruding from the tire, such as a strand or lamella, or geometric element recessed into the tire, such as a hole or striation.

A motif “formed integrally with the tire” means that this motif is made of the same material as the tire.

### SUMMARY OF THE INVENTION

The invention relates to a tire made of rubber material, comprising a tread and a sidewall, said tire comprising a marking on the tread and/or said sidewall. The marking is divided into a plurality of basic zones of the same size, each basic zone being able to be inscribed in a circle of diameter equal to 8 mm. Each basic zone comprises between 0 and N motifs. The motifs are formed integrally with the tire so as to define a grey level of the basic zone from N+1 grey levels. The grey level of a basic zone depends on the number of motifs present in this basic zone. Moreover, the marking on the tire comprises at least 5 grey levels.

The invention thus proposes realizing a complex marking on a tire, this marking comprising at least 5 grey levels. In the same way as a digital image is divided into pixels, the marking on the tire is divided into a plurality of basic zones of the same size. It is possible to provide a given grey level for each basic zone. For this purpose, each basic zone comprises motifs formed integrally with the tire. These motifs have the property of absorbing incident light before reflecting it. By varying the number of motifs in the basic zone, the grey level of this basic zone is modified. Thus, the higher the number of motifs in the basic zone, the blacker the basic zone becomes for an observer. By acting on the grey levels of the different basic zones, it is possible to realize the complex marking, for example to reproduce the details of a photograph with sufficient precision. Given that the motifs are formed directly on the tire, it is not necessary to add an additional material as in the prior art. The production of the complex marking on the tire is thus simplified. It will also be noted that the motifs in a basic zone make it possible to reflect light in proportion with the grey level of the source image.

According to non-limiting embodiments, the tire may also have one or more additional features from the following:

In one non-limiting embodiment, a basic zone is divided into N parts, a part comprising at most one motif.

These parts correspond to parts in the digital image which is used to realize said marking.

In one non-limiting embodiment, the motifs are identical.

This makes it possible to simplify the realization of the marking.

In one non-limiting embodiment, a basic zone is a polygon, each side length of which is between 0.02 mm and 5 mm.

This makes it possible to produce basic zones on an industrial scale which are not too thin or too large.

In a first non-limiting embodiment, a motif is made up of an element protruding from the tread and/or said sidewall.

This makes it possible to obtain a zone of the “velvet” type in terms of touch.

In one non-limiting variant embodiment, said protruding element is a lamella having a mean width of between 0.02 mm and 0.25 mm.

In one non-limiting variant embodiment, said protruding element is a strand having a mean cross section of between 0.0005 mm² and 1 mm².

In one non-limiting variant embodiment, said protruding element is a parallelepiped having a side length of between 0.05 mm and 0.5 mm and a height of between 0.05 mm and 0.5 mm.

In a second non-limiting embodiment, a motif is made up of an element recessed into the tread and/or said sidewall.

The zones of the marking are thus more durable. Specifically, since a zone is made up of elements recessed into the tread and/or sidewall, the impact of a road surface rubbing against a zone is reduced.

In one non-limiting variant embodiment, said recessed element forms an opening in the tread and/or said sidewall with an equivalent diameter of between 0.01 mm and 1.2 mm.

### BRIEF DESCRIPTION OF THE DRAWINGS

Other features and advantages of the invention will become apparent from the following description, given by way of non-limiting example, with reference to the attached drawings in which:

FIG. 1 schematically shows a perspective view of a part of a tire having a tread and a sidewall, said sidewall comprising a marking in accordance with the invention according to a first embodiment;

FIG. 2 schematically shows a perspective view of a part of a tire having a tread and a sidewall, said tread comprising a marking in accordance with the invention according to a second embodiment;

FIG. 3a schematically shows an enlarged view of the marking from FIG. 1 or

FIG. 2, said marking being made up of a plurality of basic zones, each basic zone making it possible to define a given grey level;

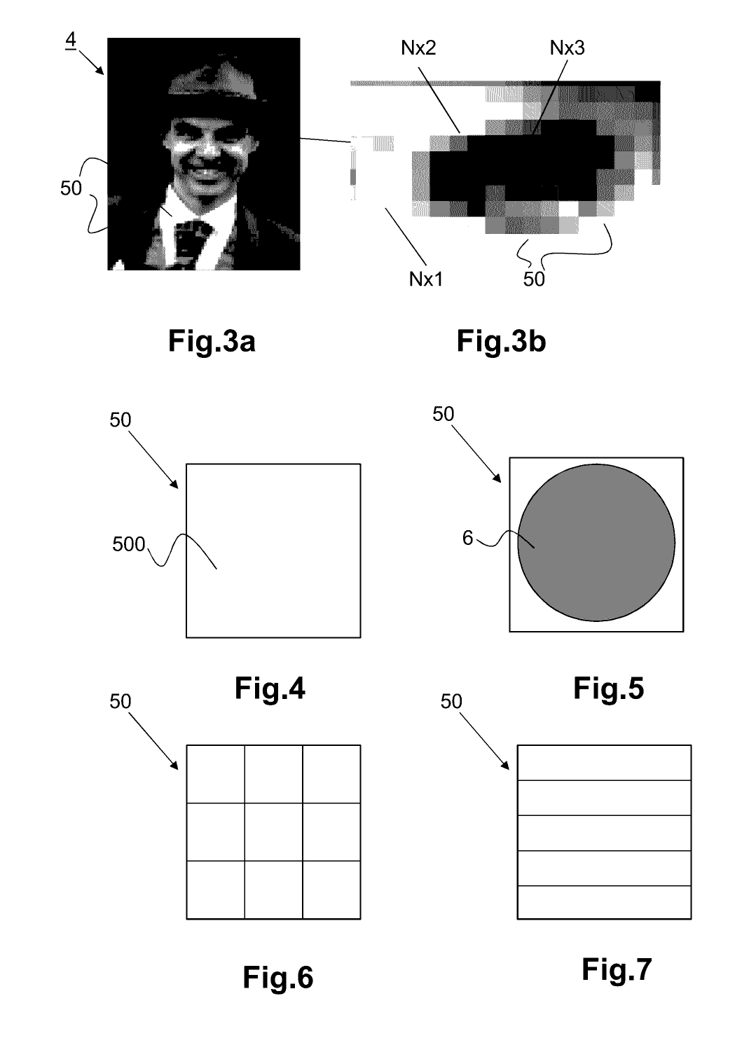

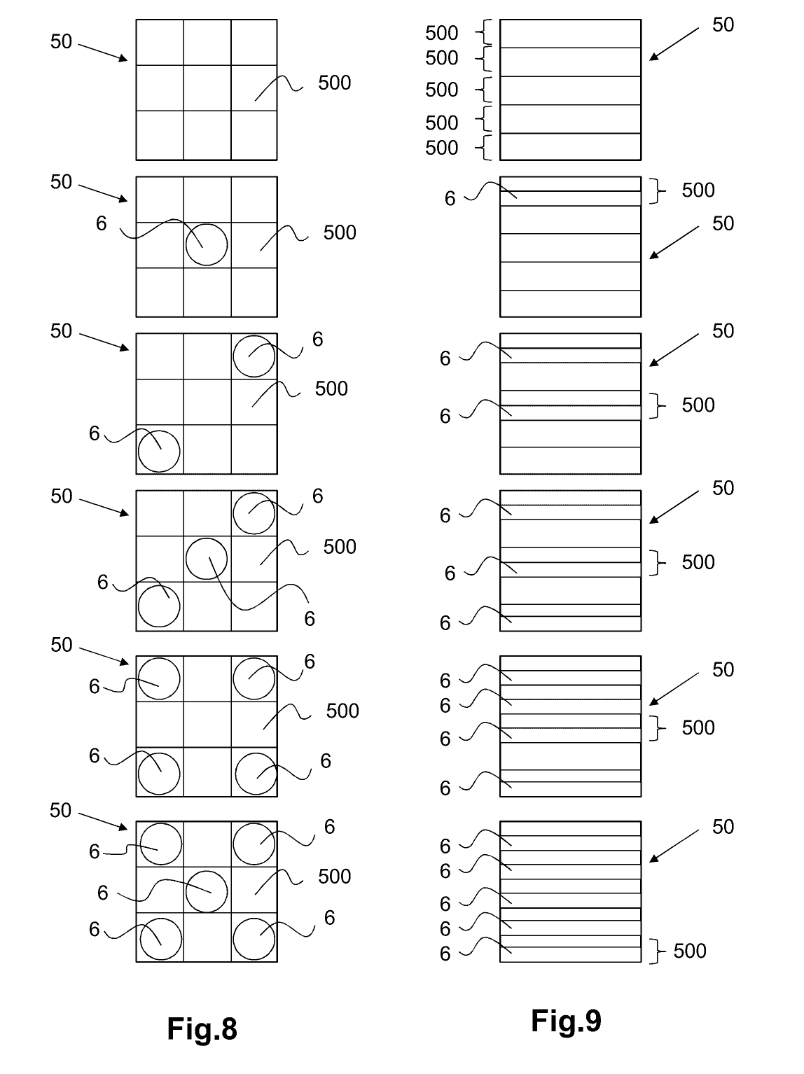

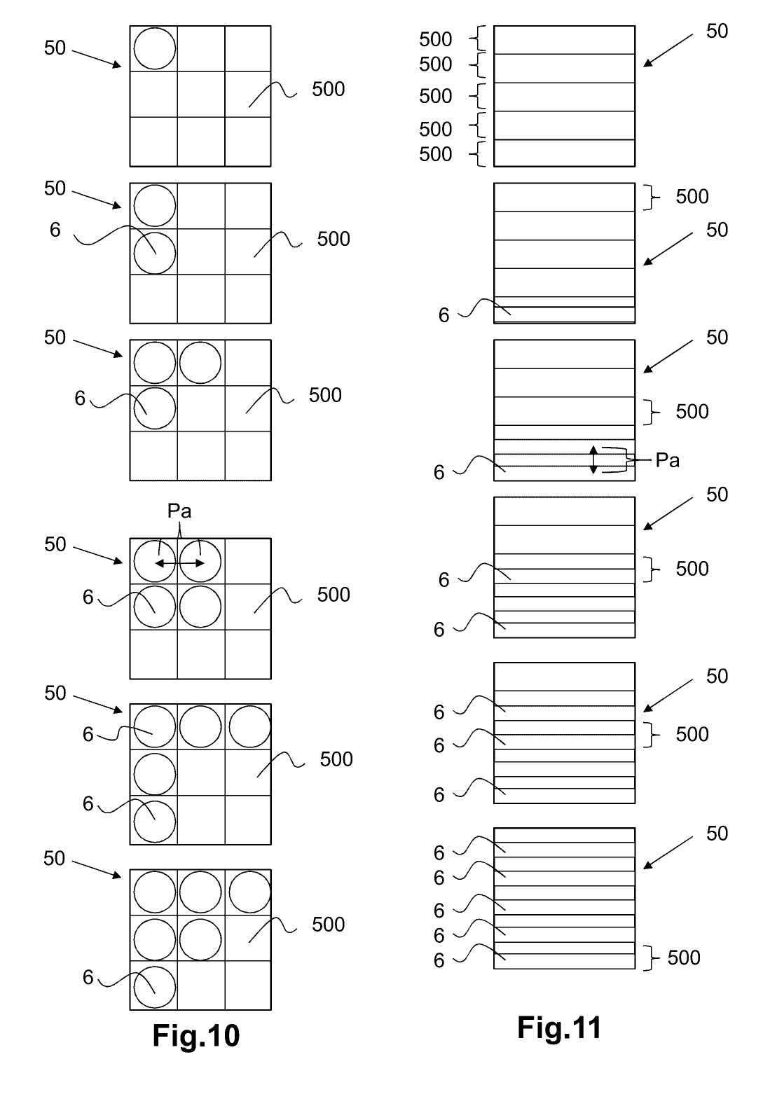

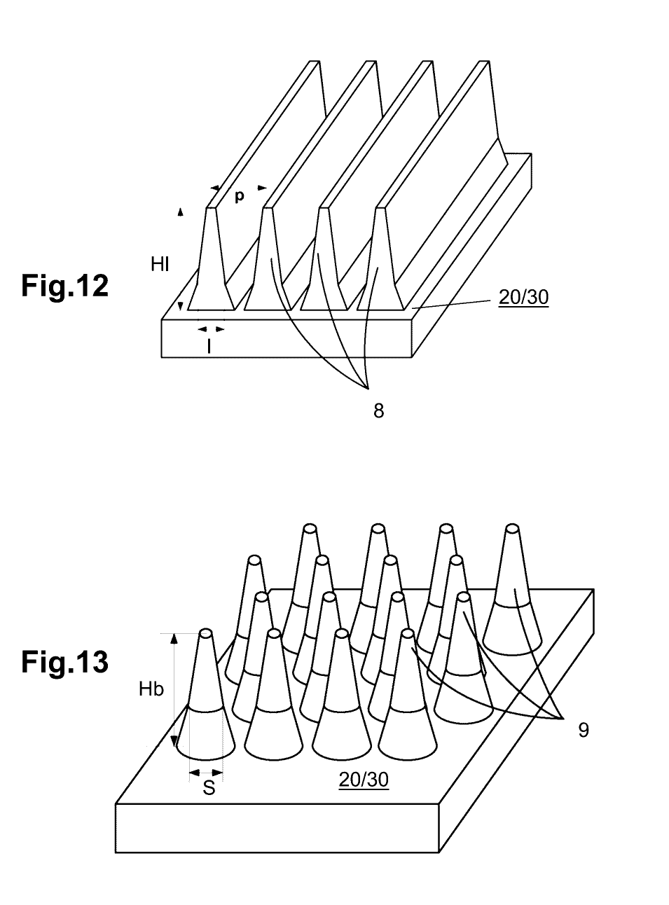

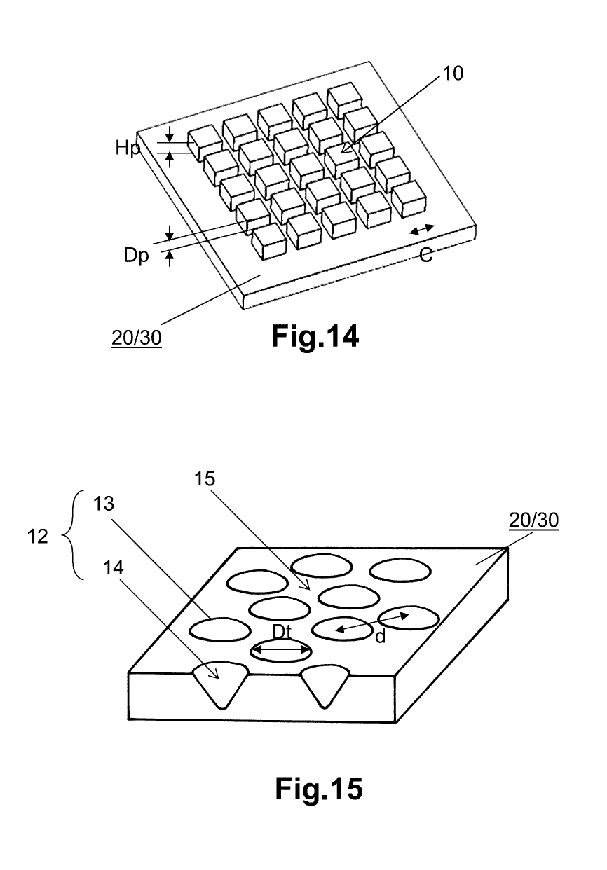

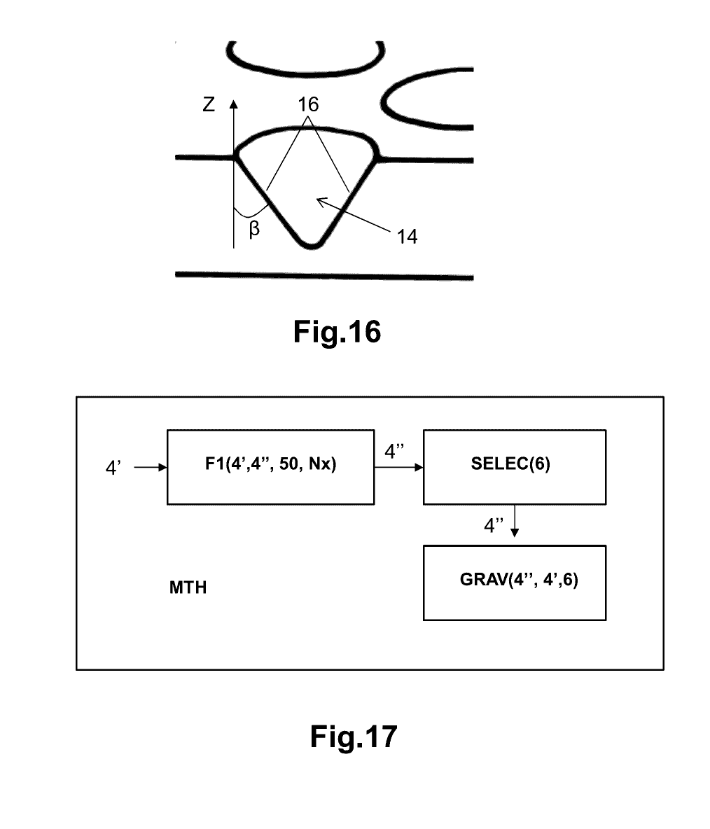

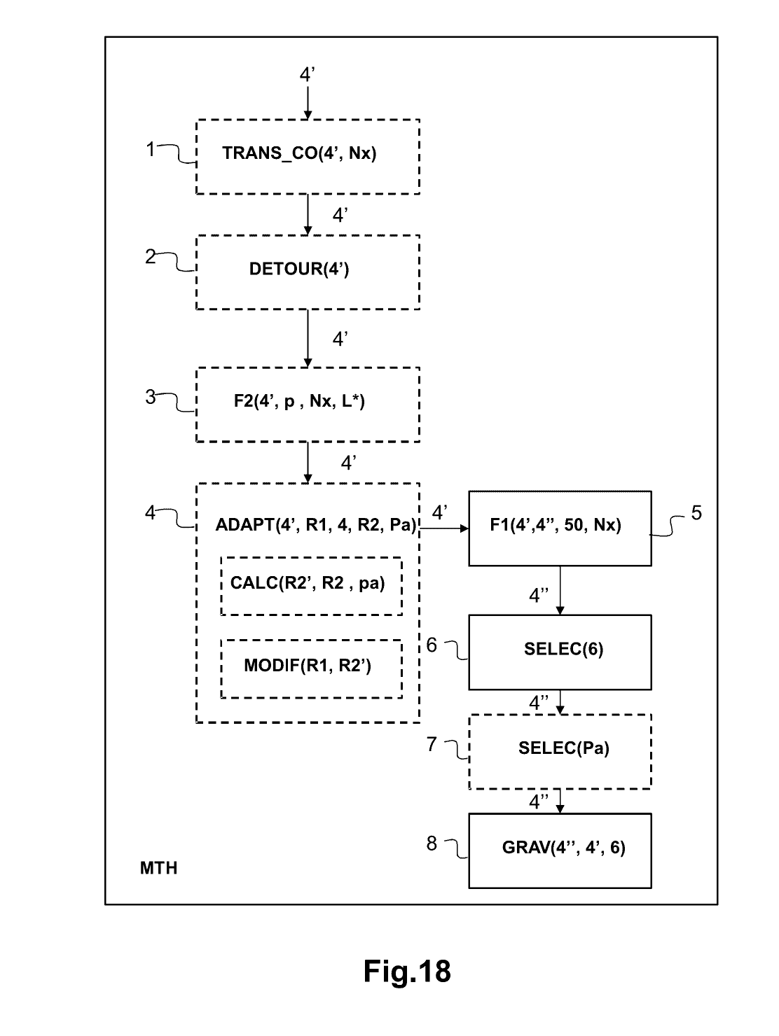

FIG. 3b is a zoomed-in view of a part of said marking from FIG. 3a;

FIG. 4 schematically shows a basic zone from FIG. 3b, said zone comprising a single part according to a first non-limiting embodiment;

FIG. 5 shows the basic zone from FIG. 4, said part of the basic zone comprising a non-limiting example of a motif;

FIG. 6 schematically shows a basic zone from FIG. 3b, said basic zone comprising a plurality of parts according to a second non-limiting embodiment and according to a first non-limiting variant embodiment;

FIG. 7 schematically shows a basic zone from FIG. 3b, said basic zone comprising a plurality of parts according to a second non-limiting embodiment and according to a second non-limiting variant embodiment;

FIG. 8 schematically shows six basic zones from FIG. 6, each basic zone comprising square parts according to a first non-limiting variant embodiment and each basic zone comprising, according to a first non-limiting example, between 0 and N motifs depending on the grey level defined by said basic zone, a motif being provided in a part of said basic zone;

FIG. 9 schematically shows six basic zones from FIG. 7, each basic zone comprising rectangular parts according to a second non-limiting variant embodiment and each basic zone comprising, according to a first non-limiting example, between 0 and N motifs depending on the grey level defined by said basic zone, a motif being provided in a part of said basic zone;

FIG. 10 schematically shows six basic zones from FIG. 6, each basic zone comprising square parts according to a first non-limiting variant embodiment and each basic zone comprising, according to a second non-limiting example, between 0 and N motifs depending on the grey level defined by said basic zone, a motif being provided in a part of said basic zone;

FIG. 11 schematically shows six basic zones from FIG. 7, each basic zone comprising rectangular parts according to a second non-limiting variant embodiment and each basic zone comprising, according to a second non-limiting example, between 0 and N motifs depending on the grey level defined by said basic zone, a motif being provided in a part of said basic zone;

FIG. 12 shows a plurality of motifs in the basic zone from FIG. 6 or FIG. 7, according to a first non-limiting variant embodiment of a first embodiment of the motif according to which the motif is made up of a protruding element;

FIG. 13 shows a plurality of motifs in the basic zone from FIG. 6, according to a second non-limiting variant embodiment of a first embodiment of the motifs according to which the motifs are made up of one and the same protruding element;

FIG. 14 shows a plurality of motifs in the basic zone from FIG. 6, according to a third non-limiting variant embodiment of a first embodiment of the motifs according to which the motifs are made up of one and the same protruding element;

FIG. 15 shows a plurality of motifs in the basic zone from FIG. 6, according to a second embodiment of the motifs according to which the motifs are made up of one and the same recessed element;

FIG. 16 shows an enlarged view of a cavity of a recessed element from FIG. 15;

FIG. 17 is a flowchart of a method for producing a marking on a tire from a source image; and

FIG. 18 is a flowchart of the method from FIG. 17, said method comprising additional steps.

In the following description, elements which are substantially identical or similar will be denoted by identical references.

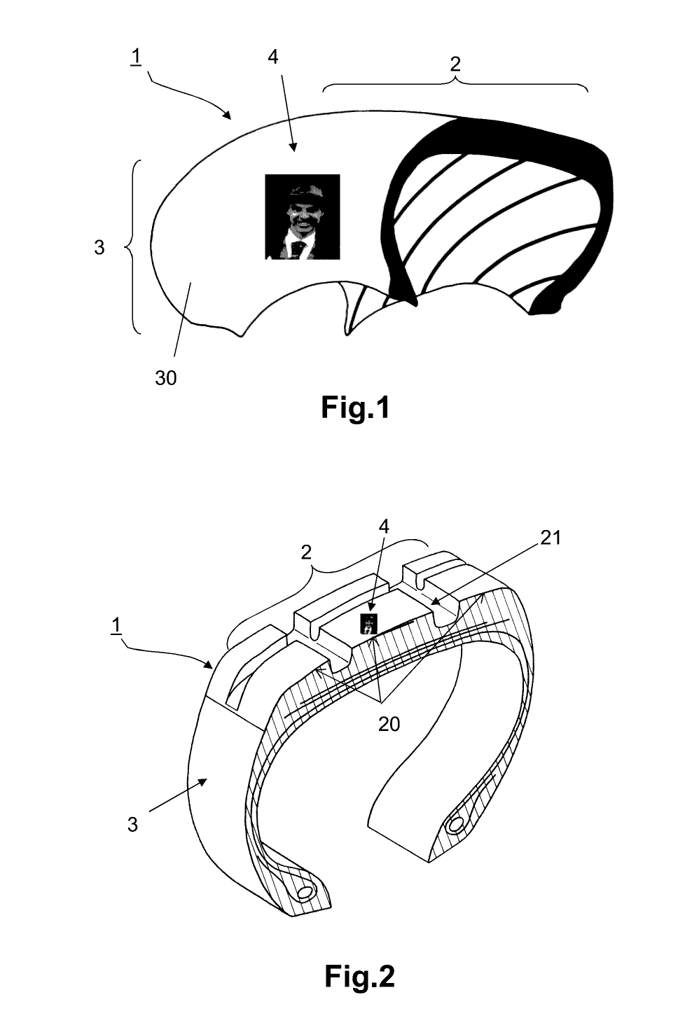

FIGS. 1 and 2 show a part of the tire 1 having a tread 2 and a sidewall 3, said tire 1 comprising a marking 4 on the tread 2 and/or said sidewall 3.

In the non-limiting example illustrated, said marking 4 represents a unit of meaning which in this case is a face.

FIG. 1 shows a part of the tire 1 having a tread 2 and a sidewall 3 according to a first non-limiting embodiment. According to this embodiment, the sidewall 3 has a marking 4 on its surface 30.

FIG. 2 shows a part of the tire 1 having a tread 2 and a sidewall 3 according to a second non-limiting embodiment. The tread 2 has grooves 21 (also referred to as tread patterns) and a tread surface 20 intended to come into contact with the ground. According to this embodiment, the tread 2 has a marking 4 on its tread surface 20.

According to the two embodiments in FIGS. 1 and 2, and according to an enlarged view in FIG. 3a, said marking 4 is made up of a plurality of basic zones 50.

FIG. 3b is a zoomed-in view of a part of the marking 4, specifically in this case an eye of the face. In one non-limiting embodiment, the basic zones 50 are identical, i.e. are the same shape. Thus, a plurality of square basic zones 50 can be seen in the non-limiting example. Each basic zone 50 makes it possible to define a particular grey level Nx. It is thus possible to see that the marking 4 has for example a first grey level Nx1 which is light grey (to the left of the eye), a second grey level Nx2 which is dark grey (above the eye), and a third grey level Nx3 which is black (in the eye), etc.

In one non-limiting embodiment, a basic zone 50 is a polygon, each side length of which is between 0.02 mm and 5 mm. The lower limit of 0.02 mm makes it possible to produce zones easily on an industrial scale, since the basic zone 50 is not too small. Furthermore, the upper limit of 5 mm makes it possible to obtain basic zones 50 that are not too large so that the marking 4 is not too rough to the naked eye. The basic zones 50 are all the same size. It will be noted that the basic zones are able to be inscribed in a circle of diameter equal to 8 mm. Preferably, the basic zones are able to be inscribed in a circle of diameter equal to 2 mm.

In one non-limiting embodiment, a basic zone 50 is divided virtually into one or more parts 500. It will be seen below that these parts 500 correspond to parts of an image in the computer file format.

In a first non-limiting variant embodiment illustrated in FIG. 4, a basic zone 50 comprises one part 500 (N=1). The part 500 makes it possible to define a single defined grey level Nx from two grey levels Nx. There is thus a first grey level corresponding to the colour white and a second grey level corresponding to the colour black. In order to realize the two grey levels Nx, a basic zone 50 and thus a part 500 comprises between 0 and 1 motif 6 depending on the grey level making up said basic zone 50 (part 500). Thus, in order to realize the colour white, the part 500 of the basic zone 50 does not comprise any motif, as illustrated in FIG. 4, whereas, in order to realize the colour black, the part 500 of the basic zone 50 comprises a motif 6 (shown in shaded form) in FIG. 5.

In a second non-limiting embodiment illustrated in FIGS. 6 and 7, a basic zone 50 comprises a plurality of parts 500, namely N parts (N>1), a zone making it possible to define a grey level Nx from N+1 grey levels Nx.

Thus, depending on the number Nb of desired grey levels Nx in a marking 4, the number of parts 50 in a basic zone 50 is determined.

In a first non-limiting variant embodiment, the part 500 forms a square, as illustrated in FIG. 6. In the non-limiting example illustrated, a basic zone 50 comprises nine squares 500.

In a second non-limiting variant embodiment, the part 500 forms a rectangle, as illustrated in FIG. 7. In the non-limiting example illustrated, a basic zone 50 comprises five rectangles 500.

According to these two variants, a grey level Nx is realized by the number of motifs 6 in a basic zone 50, each basic zone 50 comprising between 0 and N motifs 6 to define a grey level Nx from N+1 grey levels.

FIG. 8 and FIG. 9 illustrate nine parts 500 and five parts 50, respectively, which make it possible to define at most ten grey levels Nx and six grey levels Nx, respectively. A part 500 of a basic zone 50 comprises either no motif 6 or one motif 6.

In one non-limiting embodiment, illustrated in FIGS. 8 and 9, the motifs are identical.

As illustrated in FIG. 8, a part 500 has a square shape and, in face-on view, the base of the motif 6 is circular according to a non-limiting embodiment.

As illustrated in FIG. 9, a part 500 has a rectangular shape and, in face-on view, the base of the motif 6 is rectangular.

Thus, in FIG. 8, the first basic zone 50 does not have any motifs 6. This makes it possible to realize a white grey level. The four following zones 50 have 1, 2, 3 and four circular-base motifs 6, respectively, making it possible to realize increasingly dark grey levels until the darkest grey level, represented by the last basic zone 50, is reached. This last basic zone 50 comprises five motifs 6 in this case. It may be noted that, in this variant embodiment, the circular base of a motif 6 almost completely fills a part 500. The advantage is that of juxtaposing motifs maximizing the absorption of light, such as cones for example, and thus of maximizing the contrast obtained between the zones having several motifs and the zones without motifs.

In FIG. 9, the first basic zone 50 does not have any motifs 6. This makes it possible to realize a white grey level. The four following basic zones 50 have 1, 2, 3 and four rectangular-base motifs 6, respectively, making it possible to realize increasingly dark grey levels until the darkest grey level, represented by the last basic zone 50, is reached. This last basic zone 50 comprises five motifs 6 in this case. It may be noted that, in this variant embodiment, the rectangular base of a motif 6 does not completely fill a part 500. Specifically, the motif 6 only extends over half the surface area of a part 500. The advantage of this method is industrial. Laser machining machines make it possible to cut grooves rapidly.

It will be noted that the distribution of the motifs 6 in the different parts 500 of a basic zone 50 can be carried out randomly (respecting the number of motifs in a zone in order to realize the desired grey level Nx), as is the case in FIGS. 8 and 9, or in a more ordered manner as illustrated in FIGS. 10 and 11. In the more ordered distribution, a motif 6 is disposed next to another motif in order to realize the desired grey level Nx. Thus, a grey level Nx can be realized by a plurality of motifs 6 which are adjacent to one another.

Since each motif 6 has the property of deflecting, dispersing or absorbing the incident light, it is thus not tangent to the surface of the tread and/or sidewall, and is either recessed or protrudes, as will be seen below.

Two non-limiting embodiments of a motif 6 are presented below.

According to a first non-limiting embodiment, the motif 6 is made up of an element protruding from the tread 2 and/or said sidewall 3 and more particularly from the surface 30 of the sidewall 3 in the case illustrated in FIG. 1 or the tread surface 20 of the tread 2 in the case illustrated in FIG. 2. Thus, a basic zone 50 has between 0 and N protruding elements, each of the elements being distributed in a part 500.

In one non-limiting embodiment, a motif 6 (such as a strand or a lamella) is formed integrally with the tread and/or sidewall, i.e. it is produced from the same rubber material as the tread and/or the sidewall. A marking is thus obtained without addition of a further material.

The effect of these protruding elements is to “trap” a large amount of the incident light rays that strike a basic zone 50. In this first embodiment, the protruding elements make it possible to obtain not only a visual appearance of the “velvet” type since the protruding elements absorb light and thus make a basic zone 50 blacker than the tread and/or sidewall, but also a touch of the “velvet” type, said protruding elements thus providing a basic zone 50 that is pleasant to the touch.

A protruding element is described below according to different non-limiting variant embodiments and in relation to the different variant embodiments of a part 500 (square shape or rectangular shape) of a basic zone 50.

Thus, when the part 500 is a rectangle, in one non-limiting variant embodiment, said protruding element is a lamella 8 having a mean width of between 0.02 mm and 0.25 mm, as illustrated in FIG. 12. It will be noted that the mean width corresponds to the mean of the widths 1 measured at regular intervals over the height H1 of the lamella, the height of each lamella being between 0.05 and 0.5 mm.

When the basic zone 50 comprises only one part 500, it either comprises only one lamella 8 or no lamella 8 so as to realize one of the two desired grey levels Nx.

When the basic zone 50 comprises a plurality of parts 500, one part 500 comprises a single lamella 8 or no lamella 8. It is possible for a part 500 to have only one lamella 8.

When the part 500 is a square, different variant embodiments are possible for the protruding element and are described below.

In a first non-limiting variant embodiment illustrated in FIG. 13, said protruding element is a strand 9 having a mean cross section S of between 0.0005 mm² and 1 mm². It will be noted that the mean cross section of each strand corresponds to the mean of the cross sections S measured at regular intervals from the base of the strand. The strands 6 have a conical overall shape with a cross section that decreases over the height Hb of these strands.

When the basic zone 50 comprises only one part 500, it either comprises only one strand 9 or no strand 9 so as to realize one of the two desired grey levels Nx.

When the basic zone 50 comprises a plurality of parts 500, one part 500 comprises a single strand 9 or no strand 9. It is possible for a part 500 to have only one strand 9.

In a second non-limiting variant embodiment illustrated in FIG. 14, said protruding element is a parallelepiped 10 having a side length C of between 0.05 mm and 0.5 mm and a height Hp of between 0.05 mm and 0.5 mm.

When the basic zone 50 comprises only one part 500, it either comprises only one parallelepiped 10 or no strand 10 so as to realize one of the two desired grey levels Nx.

When the basic zone 50 comprises a plurality of parts 500, one part 500 comprises a single parallelepiped 10 or no parallelepiped 10. It is possible for a part 500 to have only one parallelepiped 10.

Thus, depending on the desired grey level Nx, the number of protruding elements in a basic zone 50 is varied. The more protruding elements there are in a basic zone 50, the darker the grey level. The maximum number of protruding elements in a zone makes it possible to obtain a black colour. It will be noted that when a basic zone 50 formed by protruding elements is of the velvet type, it absorbs a maximum of incident light.

When there is no protruding element in a basic zone 50, a white colour is obtained. In this case, the white colour is realized by a smooth surface (that of the tread 2 and/or sidewall 3) which has very low surface roughness of parameter Ra. In one non-limiting example, the arithmetic mean deviation parameter Ra representing the surface roughness is less than 30 μm. This smooth surface reflects a maximum of incident light. The quantity of light reflected by a white basic zone 50 is thus maximized.

For the intermediate grey levels, the target grey level to be realized defines the percentage of surface of the basic zone 50 that is required to reflect light, the rest of the basic zone 50 being required at most to absorb light.

Thus, in one non-limiting example as illustrated in FIG. 9 or in FIG. 11, when 6 grey levels are defined (a zone thus having 5 parts 500), there is the following distribution of the number of protruding elements per basic zone 50.

| | Smooth | Number of |
|---|---|---|
| Grey level | surface | protruding elements |
| White (1) | 100% | 0 |
| Light grey (2) | 83% | 1 |
| Medium grey (3) | 66% | 2 |
| Dark grey (4) | 32% | 3 |
| Darker grey (5) | 16% | 4 |
| Black (6) | 0% | 5 |

In another non-limiting example as illustrated in FIG. 8 or in FIG. 10, when 10 grey levels are defined (a zone thus having 9 parts 500), there is the following distribution of the number of protruding elements per basic zone 50.

| | Smooth | Number of |
|---|---|---|
| Grey level | surface | protruding elements |
| White (1) | 100% | 0 |
| (2) | 88.9% | 1 |
| Light grey (3) | 77.8% | 2 |
| (4) | 66.7% | 3 |
| Medium grey (5) | 55.6% | 4 |
| (6) | 44.4% | 5 |
| Dark grey (7) | 33.3% | 6 |
| (8) | 22.2% | 7 |
| (9) | 11.1% | 8 |
| Black (10) | 0% | 9 |

According to a second non-limiting embodiment, a motif 6 is made up of an element 12 (also referred to as a hole) recessed into the tread 2 and/or said sidewall 3 and more particularly into the surface 30 of the sidewall 3 in the case illustrated in FIG. 1 or the tread surface 20 of the tread 2 in the case illustrated in FIG. 2. A recessed element 12 is made up of an opening 13 in the surface and of an associated cavity 14 extending into the depth of the surface.

This second embodiment applies when the part 500 of a basic zone 50 forms a square. Thus, a motif 6 is made up of a recessed element which forms an opening 13 in the tread 2 and/or said sidewall 3 with an equivalent diameter Dt of between 0.01 mm and 1.2 mm.

An opening 13 continues into the depth of the surface to form a cavity 14. Thus, a basic zone 50 has between 0 and N recessed elements, each element being distributed in a part 500.

The effect of these cavities 14 is to “trap” a large amount of the incident light rays that strike a basic zone 50, but also to make the basic zone 50 more durable. Specifically, since the cavities 14 are recessed into the surface, the impact of mechanical attack on the basic zone 50, such as rubbing by a road surface, is lower than for protrusions. In this second embodiment, the recessed elements make it possible to obtain a visual appearance of the “velvet” type since the cavities absorb light and thus make a basic zone 50 blacker than the tread and/or sidewall.

In one non-limiting embodiment, a cavity 14 has a depth at least equal to 0.1 mm. In one non-limiting variant embodiment, a cavity 14 has a depth of between 0.2 mm and 0.6 mm. This ensures that a large amount of incident light rays that strike a basic zone 50 are trapped by said zone and, since the depth of the cavities is limited, also prevents the mechanical strength of the surface 20 and/or 30 from deteriorating excessively.

FIG. 15 illustrates the recessed element 12 according to a non-limiting variant of this second embodiment. In this variant, a cavity 14 is in the form of a cone which extends into the depth of the surface 20 and/or 30 and leads onto the surface, forming a circular opening 13. A cavity 14 thus has a cross section which decreases with depth into the surface. This improves the contrast of the basic zone 50 with the rest of the tire.

FIG. 16 is a zoomed-in view of a cavity 14 of a recessed element from FIG. 15. In one non-limiting embodiment, a cavity has at least one wall 16 which, in cross section, forms an angle β of between 10° and 60° with respect to a direction Z perpendicular to the basic zone 50.

Each time a light ray strikes a wall 16 of the cavity 14, this ray is reflected by said wall 16. The direction of reflection of the light ray depends on the initial direction of this light ray and on the inclination angle of the wall 16. Thus, depending on this initial direction and on this inclination angle, the light ray can be sent towards another wall 16 of the cavity. By contrast, the light ray can be sent to the outside of the cavity, for example directly towards an observer. In the first case, the light ray is “lost” in the cavity and will no longer be perceptible to an observer. In the second case, the observer can perceive the light ray and the basic zone 50 can then appear to be lighter and thus to contrast less with the tread and/or sidewall. Choosing a cavity 14 having at least one wall 16 which forms an angle β of between 10° and 60° ensures that a large part of the light rays entering the cavity 14 will be absorbed by this cavity under the effect of multiple reflections inside the cavity. This improves the contrast of the basic zone 50 with the tread and/or sidewall. Moreover, with this wall inclination, the strength of the basic zone 50 is improved overall, notably in the event of repeated rubbing against the road surface.

In the same way as for the protruding elements, depending on the desired grey level Nx, the number of recessed elements in a basic zone 50 is varied.

The marking 4 on the tire 1 made of rubber material comprising a tread 2 and a sidewall 3 is produced from a source image 4′ by means of a production method MTH illustrated in FIGS. 17 and 18.

It will be noted that the source image 4′ is an image in the form of a computer file such as files of the bitmap or jpeg type (also referred to as a digital image). Moreover, its resolution is generally fairly high, for example around 3000 pixels by 3000 pixels.

As illustrated in FIG. 17, the production method MTH comprises:

a first operation of processing the source image 4′ into a target image 4″ made up of a plurality of identical basic zones 50, each basic zone 50 defining a grey level Nx from N+1 grey levels Nx (illustrated step F1(4′, 4″, 50, Nx));

the selection of one or more motifs 6 to realize the grey levels Nx of said zones 50 (illustrated step SELEC(6));

the realization of the marking 4 from said target image 4″, the marking comprising a plurality of motifs 6 (illustrated step GRAV(4, 6)).

The steps are described in more detail below.

The first processing operation on the source image 4′ will make it possible to obtain a target image 4″ made up of a plurality of identical basic zones 50. During this processing operation, the number of parts 500 in a basic zone 50 of the target image 4″ is also defined depending on the number Nb of grey levels Nx to be obtained in the target image 4″. These parts 500 will thus allow the distribution and positioning of the motifs 6 in the marking 4 and aid the industrial production of said marking 4. This processing operation is carried out by appropriate image processing software.

This processing operation thus makes it possible to define the desired number of grey levels Nx in the target image 4″. It will be noted that, starting from 8 grey levels, an observer of the tire will start to no longer perceive the discontinuities of grey levels distinctly. It will be recalled that, by its nature, the rubber material of the tire 1 absorbs more than 90% of incident light. In this context, it is possible to make do with a small number of grey levels Nx without sacrificing the level of visual quality obtained. The processing operation thus reduces the number of grey levels Nx compared with the number of grey levels defined in the source image 4′. In one non-limiting exemplary embodiment, the number Nb of grey levels is between 2 and 10.

Thus, if 2 grey levels are to be obtained, a basic zone 50 of the target image 4″ will only have one part 500 as described above. If 10 grey levels are to be obtained, a basic zone 50 will have 9 parts 500 as described above.

The target image 4″ obtained after this first step is an image which is still in the form of a computer file.

The selection of one or more motifs 6 for realizing the grey levels Nx of said basic zones 50 makes it possible to define said motifs as an input parameter for the machine M which will produce the marking 4. In a first non-limiting embodiment, one motif 6 will be selected. A basic zone 50 will comprise between zero and N occurrences of one and the same motif 6. In a second non-limiting embodiment, a plurality of motifs will be selected. A basic zone 50 will comprise between zero and N motifs 6 of different shapes.

In one non-limiting embodiment, the marking 4 is produced by laser etching by means of a laser etching machine M on a mould or directly on said tire 1.

In a first embodiment, the etching of the marking 4 is carried out on a mould. In a second embodiment, it is carried out directly on said tire 1. Thus, the etching of the marking 4 is carried out before or after the curing of the tire 1. Said etching comprises the etching of a plurality of motifs 6, each basic zone 50 of which the marking 4 is made up comprising between 0 and N motifs 6 so as to define a grey level Nx from N+1 grey levels Nx. A grey level Nx is thus realized by repetition of one and the same motif 6 (when one motif is used) or of a plurality of motifs 6.

In one non-limiting example, the laser etching machine M is a pulsed laser which, in one non-limiting example, has a power of 50 W and a rate of 1000 mm/s and which functions at a frequency of 50 kHz.

In one non-limiting embodiment, said method also includes the definition of the spacing Pa between two adjacent motifs 6 to be produced on the tire 1 (step SELEC(Pa) illustrated in dotted lines).

The choice of the spacing Pa to be realized on the tire 1 is set on the laser etching machine M. Thus, the spacing Pa is defined as an input parameter for the machine M. In one non-limiting embodiment, the spacing Pa is between 0.2 mm and 1 mm. This allows production on an industrial scale. It will be noted that the smaller the spacing Pa, the more precise the marking will be. As illustrated in FIG. 10 and FIG. 11, a spacing Pa between two adjacent motifs 6 is defined with respect to a median passing through the centre of each motif. This step can be carried out at any time in the method.

It will be noted that if the source image 4′ is in colour, in one non-limiting embodiment, the method MTH also comprises conversion of the colour source image 4′ into a source image 4′ in grey levels (step TRANS_CO(4′, Nx) illustrated in dotted lines in FIG. 18).

Furthermore, in one non-limiting embodiment, the method MTH also comprises the cropping of the source image 4′. This makes it better to highlight the unit of meaning in the source image 4′ once it has been transferred onto the tire (step DETOUR(4′) illustrated in dotted lines in FIG. 18).

In one non-limiting embodiment, the method also includes a second processing operation (step F2(4′, p, Nx, L*) illustrated in dotted lines in FIG. 18) in which parameters p of the source image 4′ are set such that at least at least five percent of the grey levels Nx of said source image 4′ have a lightness value L* less than 20 and at least five percent of the grey levels Nx of said source image 4′ have a lightness value L* greater than 80. In one non-limiting example, these parameters p are the contrast and/or the lightness and/or the gamma parameter.

Thus, the source image 4′ is adjusted so as to obtain a marking 4 on the tire which is most similar to the source image 4′, notably by virtue of the adjustment of the gamma parameter (also referred to as gamma correction). It will be noted that it is possible to check the gamma correction by means of a histogram of values of pixels of the source image 4′.

The rubbers of which the tires are made are typically anthracite grey in colour. The maximum amplitude of contrast on these materials is low since the maximum lightness is around 25. This step therefore makes it possible to maximize the contrast made on the tire for an observer, on the background formed by the rubber material of the tire. The loss of the maximum amplitude of contrast brought about by the material is thus minimized.

The adjustment of the parameter of contrast makes it possible to clearly perceive the difference between the dark grey levels and the light grey levels.

This second processing operation makes it possible to obtain a marking 4 on the tire which has a lightness L* of between 8 and 25. Thus, the lightest zones of the marking 4 approach the lightness of 25 while the darkest zones of the marking 4 approach the lightness of 8. Grey levels are thus obtained on the marking 4 which are sufficiently visible on the tire to make said marking 4 stand out on the tire.

The step of converting the colour image is carried out before the second processing operation. The cropping step can be carried out before or after the second processing operation.

The first processing operation described above is carried out on the source image 4′ obtained after these three additional steps.

Finally, in one non-limiting embodiment, the method MTH also comprises adaptation of the resolution R1 of said source image 4′ depending on the desired resolution R2 of the marking 4 on said tire 1 and the spacing Pa between two adjacent motifs in said marking 4 (step ADAPT(4′, R1, 4, R2, Pa) illustrated in dotted lines in FIG. 18).

This allows fine control of the final rendering before carrying out etching during simulations and computer conversion, and makes it possible to prepare the running of the etching machine in accordance therewith.

The resolution R1 is the number of pixels which make up the source image 4′ in height and width. The resolution R2 is the number of millimetres which make up the marking 4 in height and width on the tire 1, namely the space on the tire 1 in millimetres that is dedicated to said marking 4.

The source image 4′ should in fact have a resolution R1 suitable for the visual effect ultimately desired on the tire 1.

The adaptation of said resolution R1 depending on the resolution R2 comprises the following sub-steps:

In a first sub-step (illustrated CALC(R2′, R2, Pa) in FIG. 18), the resolution R2′ of a digital image in pixels is calculated, corresponding to the resolution R2 of the marking 4 to be realized on the tire 1 in millimetres.

To this end, the resolution R2′ is equal to said resolution R2 divided by said spacing Pa. Thus, in one non-limiting example, if the available space for inscribing a marking 4 on the tire 1 is 30 mm×30 mm (resolution R2) and the spacing Pa of the etching is fixed at 0.3 mm, this means that it is possible to etch on the tire 1 a marking 4 corresponding to an image of resolution R2′ equal to 30 mm/0.3 mm=100 pixels×100 pixels. By virtue of this formula, a physical space available on the tire 1 is transcribed into a resolution of a digital image.

In a second step (illustrated MODIF(R1, R2′) in FIG. 18), depending on the calculated resolution R2′ in pixels corresponding to the resolution R2 of the marking 4, the resolution R1 of the source image 4′ is modified. Thus, the resolution R1, which was initially 3000×3000 pixels is modified so as to obtain a new resolution R1 equal to 100×100 pixels. Thus, 30 pixels (=3000/100) of the source image 4′ with the old resolution R1 correspond to 1 pixel of the reduced source image 4′ with the new resolution R1. This means that the grey level Nx defined by one pixel in the reduced source image 4′ is equal to the grey level Nx defined by a square of 30×30 pixels in the source image 4′ obtained just after the second processing operation in the example illustrated in FIG. 18.

This additional adaptation step ADAPT(4′, R1, 4, R2, Pa) is carried out before the first step of processing the image F1(4, 4″, 50, Nx).

FIG. 18 illustrates the method MTH for producing the marking 4 including these three additional steps (conversion of the colour image, cropping and adaptation).

Thus, in a first step 1), the colour source image 4′ is converted into a source image 4′ comprising several grey levels Nx.

Next, in a second step 2), the image 4′ is cropped so as to retain only the unit of meaning; the face, in the example in question.

In a third step 3), the parameters of said source image 4′ are adjusted.

In a fourth step 4), the resolution R1 of the source image 4′ is adapted depending on the desired resolution R2 of the marking 4 to be produced on the tire 1.

This step comprises:

the sub-step 40) of calculating the resolution in pixels R2′ of an image depending on the resolution in millimetres of the marking 4 to be produced on the tire, namely the calculation of the resolution in pixels depending on the space dedicated to said marking 4 on the tire;

the sub-step 41) of modifying the resolution R1 of the source image 4′ depending on the calculated resolution in pixels R2′. The modification corresponds here to a reduction in the resolution R1.

In a fifth step 5), the source image 4′ (the size R1 of which has been modified to define the marking 4) is processed to obtain a target image 4″ made up of a plurality of identical basic zones 50, i.e. the number of grey levels Nx to be obtained on the tire 1 in the marking 4 is defined, this amounting to defining the number of parts 500 in a basic zone 50.

In a sixth step 6), the laser etching machine M is set to the value of the spacing Pa between two adjacent motifs 6 to be realized, said spacing being measured on the tire 1.

In a seventh step 7), the motif(s) 6 for realizing the marking 4 is/are selected.

In an eighth step 8), the machine M produces the motifs 6 in the basic zones 50 so as to realize the marking 4 on the tire 1 with the different grey levels Nx.

It will be noted that, in the first embodiment in which a basic zone 50 only has two grey levels Nx, i.e. the colour white or the colour black, the laser etching machine M only etches one of the two grey levels. In one non-limiting example, it etches the colour black, the colour white being realized by the smooth surface of the tread and/or sidewall on which the marking 4 is located.

The invention is not limited to the examples described and shown and various modifications can be made thereto without departing from its scope.

Thus, according to another nonlimiting variant embodiment, when a part 500 is square, a plurality of motifs 6 can be realized by means of one and the same protruding element which is a lamella 8. In this case, the motifs are adjacent to one another and aligned along a single line (horizontal or vertical) in one basic zone 50.

Thus, according to another non-limiting variant embodiment, the openings 13 from FIG. 15 can have a circular, square or polygonal (for example hexagonal) shape and the corresponding cavities 12 can have a cylindrical, parallelepipedal or polygonal shape.

Thus, according to another non-limiting variant embodiment, the tread 2 of the tire and/or the sidewall 3 can each have one or more markings 4.

Thus, according to another non-limiting variant embodiment, instead of using a technology of the velvet type to produce a motif 6, a motif 6 is produced by simple excavation carried out by the laser. In one non-limiting example, the excavation has a depth of between 0.1 and 0.5 mm.

Thus, according to another non-limiting variant embodiment, the basic zones 50 can have a hexagonal shape.

In short, the method for realizing the marking comprises:

a first operation of processing the source image into a target image made up of a plurality of identical zones, each zone defining a grey level from N+1 grey levels;

the selection of one or more motifs to realize the grey levels of said zones;

the realization of the marking from said target image, the marking comprising a plurality of motifs.

This method thus makes it possible to obtain grey levels on the marking which are sufficiently visible on the tire to make said marking stand out on the tire.

In one non-limiting embodiment, the production method also includes a second processing operation in which parameters of the source image are set such that at least five percent of the grey levels of said source image have a lightness value less than 20 and at least five percent of the grey levels of said source image have a lightness value greater than 80.

This makes it possible to obtain a marking on the tire which closely resembles the source image.

In one non-limiting embodiment, the production method also includes the definition of the spacing between two adjacent motifs to be produced on the tire.

In another non-limiting embodiment, the production method also comprises adaptation of the resolution of said source image depending on the desired resolution of said marking on said tire and the spacing between two adjacent motifs in the marking.

This makes it possible to adapt the source image to the background of the tire. This makes it possible to transpose a marking in a physical space, in this case on the tire, into an image in a corresponding computer format.

In one non-limiting embodiment, the marking is produced by laser etching by means of a laser etching machine on a mould or directly on said tire.

The invention described in the present document has notably the following advantages:

It increases the quality of markings perceived on a tire;

It makes it possible to realize high quality markings by means of already existing industrial techniques. The production costs are thus low;

It makes it possible to obtain a plurality of grey levels in a marking on the tire which is similar to the grey levels of the source image (after processing of said source image), this making it possible to obtain photorealistic rendering;

It allows an observer of the tire to clearly perceive the marking on the tire, regardless of the direction and intensity of the light illuminating the tire, and not just when the light is low-angled;

It makes it possible to have precise markings on the tire: it is thus possible to obtain a marking on a tire with photorealistic rendering;

It makes it possible to obtain a maximum contrast by virtue of a “velvet” type motif.

1. A tire made of rubber material, comprising a tread and a sidewall, said tire comprising a marking on the tread and/or said sidewall, wherein said marking is divided into a plurality of basic zones of the same size, each said basic zone being able to be inscribed in a circle of diameter equal to 8 mm, each said basic zone comprising between 0 and N motifs, said motifs being formed integrally with the tire so as to define a grey level (Nx) of the basic zone from N+1 grey levels (Nx), the grey level of a said basic zone depending on the number of motifs present in this basic zone, and wherein the marking on the tire comprises at least 5 different grey levels.

2. The tire according to claim 1, wherein a basic zone is divided into N parts (500), a part comprising at most one said motif.

3. The tire according to claim 1, wherein the motifs are identical.

4. The tire according to claim 1, wherein a basic zone is a polygon, each side length of which is between 0.02 mm and 5 mm.

5. The tire according to claim 1, wherein a motif is made up of an element protruding from the tread and/or said sidewall.

6. The tire according to claim 1, wherein said protruding element is a lamella having a mean width of between 0.02 mm and 0.25 mm.

7. The tire according to claim 1, wherein said protruding element is a strand having a mean cross section of between 0.0005 mm² and 1 mm².

8. The tire according to claim 1, wherein said protruding element is a parallelepiped having a side length of between 0.05 mm and 0.5 mm and a height of between 0.05 mm and 0.5 mm.

9. The tire according to claim 1, wherein a motif is made up of an element recessed into the tread and/or said sidewall.

10. The tire according to claim 9, wherein said recessed element forms an opening in the tread and/or said sidewall with an equivalent diameter (Dt) of between 0.01 mm and 1.2 mm.

11. The tire according to claim 1, wherein the marking is a photographic representation.
